(19) United States
(12) Patent Application Publication
(10) Pub. No.: US 2018/0043391 A1
(43) Pub. Date: Feb. 15, 2018

(54) PAINTING TAPE SYSTEM

(71) Applicant: Ceronda Jules, Miami, FL (US)

(72) Inventor: Ceronda Jules, Miami, FL (US)

(21) Appl. No.: 15/236,442

(22) Filed: Aug. 14, 2016

(51) Int. Cl. B05C 21/00; B44D 3/22; B05B 15/04; B32B 7/12; B32B 7/06

(52) U.S. Cl. CPC B05C 21/005; B32B 7/12; B32B 7/06; B05B 15/0456; B44D 3/225

(57) ABSTRACT

A paint tape system is provided having a base tape and a base tape liner for accurately mounting on a surface to be painted and applying paint on said surface utilizing a paint cavity formed by use of the system.

### BACKGROUND OF THE INVENTION

There are a variety of painter tape systems currently available. However, the systems have a significant limitation in fact they require a particular level of skill and precision in positioning in order to provide parallel lines. There is a need for improvement that will address this deficiency.

### SUMMARY OF THE INVENTION

The present invention addresses the need by providing a two layer system whereby the two layers are placed on a mounting surface, the top layer is removed exposing the bottom layer that is constructed and arranged to form a paint receiving cavity. By paint receiving cavity, as described herein, it refers to a space in which paint can be applied and removal of the bottom layer from a mounting surface imparts a desired shape of the applied paint.

In one embodiment, the present invention is a paint tape system comprising:
a base tape having a planer upper surface and planer lower surface having releasable adhesive disposed thereon; and
a releasable portion releasable from said base tape whereby removing said reliable portion imparts a paint channel.

The system includes two base tape liners substantially parallel one to another. Often, painters encounter problems in that separate sections of tape are applied and are not substantially parallel. When painting the area between two strips of applied painters tape, the resulting block has non-parallel edges that must be corrected.

In one embodiment, the system of includes three base tape liners substantially parallel to each other.

In one embodiment, the system of includes a plurality of cut out stencil shapes incorporated thereon.

The system is contemplated s being a single plane with a removable section, or in one embodiment, further including a second layer being a base tape liner having a planer upper surface and planer lower surface having releasable adhesive disposed thereon, said base tape liner, when mounted on a surface imparting at least paint receiving cavity constructed and arranged for applying paint therein.

Also contemplated is a method of applying paint using a paint tape system, said method comprising the steps of:
providing a paint tape system as described herein;
unrolling a desired length of tape from said system;
cutting said desired length;
affixing said base tape lined on a surface to be painted;
removing said base tape;
exposing said paint receiving cavity by said removing of said base tape liner;
applying paint to said paint receiving cavity;
optionally, waiting for said paint to dry; and

removing said base tape liner.

### BRIEF DESCRIPTION OT THE SEVERAL VIEWS OF THE DRAWINGS

FIG. 1 is a perspective view demonstrative of a painter tape system according to one embodiment of the present invention.

FIG. 2 is a perspective view of a painter tape system in an environment of use according to one embodiment of the present invention.

FIG. 3 is a perspective view demonstrative of a single paint area with parallel borders according to one embodiment of the present invention.

FIG. 4 is a sequential view from FIG. 3 demonstrative of a painted area when border portions are removed.

FIG. 5 is a perspective view demonstrative of two painted areas with parallel borders according to one embodiment of the present invention.

FIG. 6 is a sequential view from FIG. 5 demonstrative of the two painted areas when border portions are removed.

FIG. 7 is a perspective view of one embodiment of the present invention whereby the painter tape provided has a plurality of shaped cavities that allow for painting shapes defined by the cavities.

FIG. 8 is a sequential view from FIG. 7 with the border portions removed.

FIG. 9 is a perspective view of a single layer embodiment of the present invention.

FIG. 10 is side view showing the paint receiving cavity.

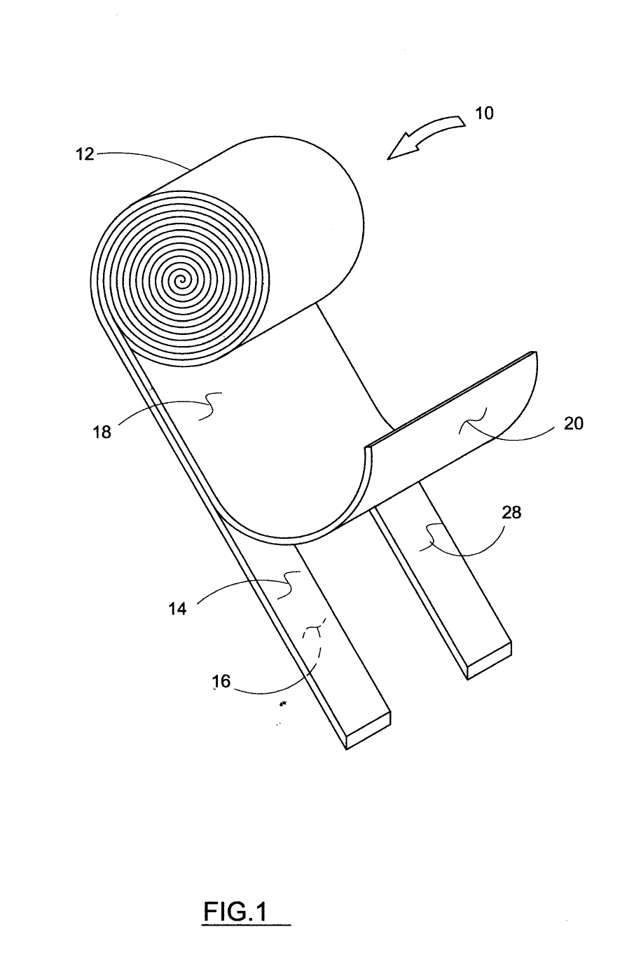

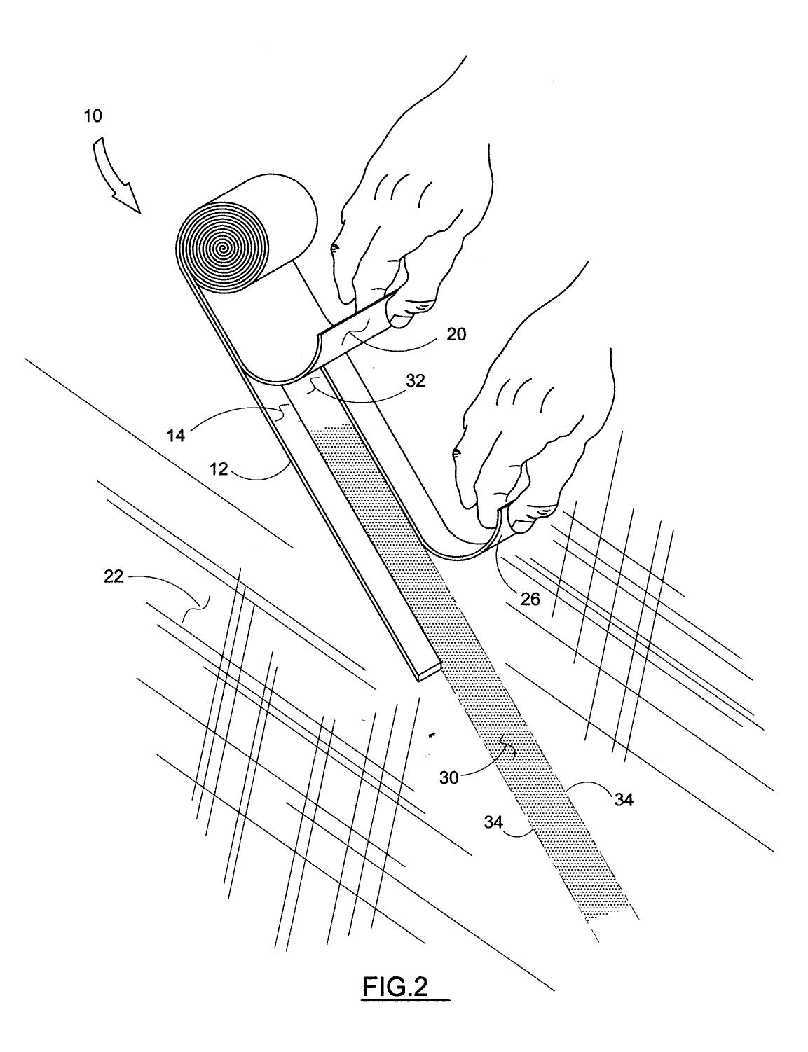

### DETAILED DESCRIPTION OF THE PREFERRED EMBODIMENT

The present invention provides a painter tape system 10 whereby a base tape liner 12 includes a first or upper surface 18 and a second or lower surface 20. Lower surface 20 has attached thereto border tape 12 that is formed of a first or upper surface 14 and a second or lower surface 26. Lower surface 20 is releasably attached to upper surface 14 utilizing suitable releasable adhesive 28. Lower surface 26 is releasably attached to surface 22 whereby surface 22 is any surface in which a user ultimately desires to apply paint and or other pigmented or coloring materials.

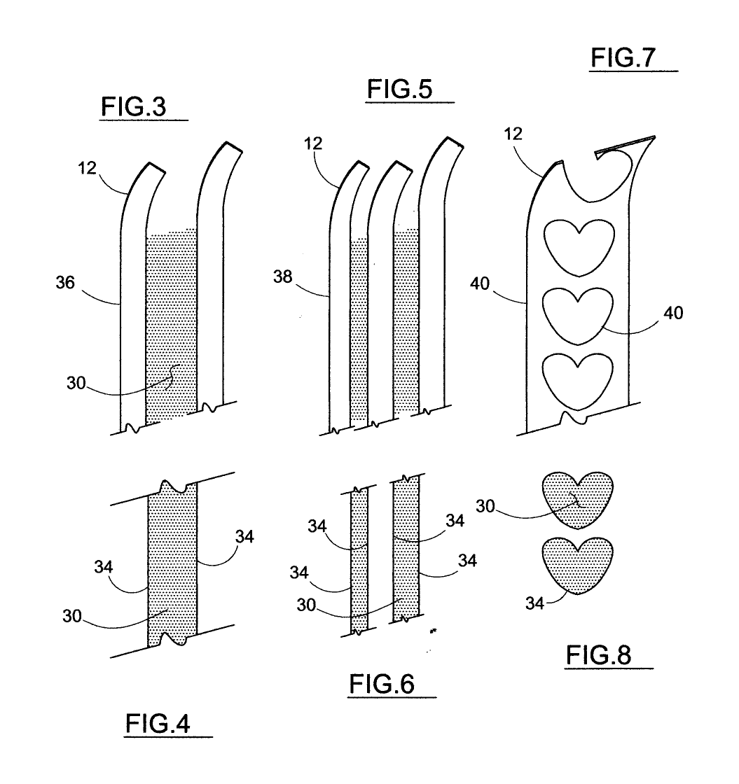

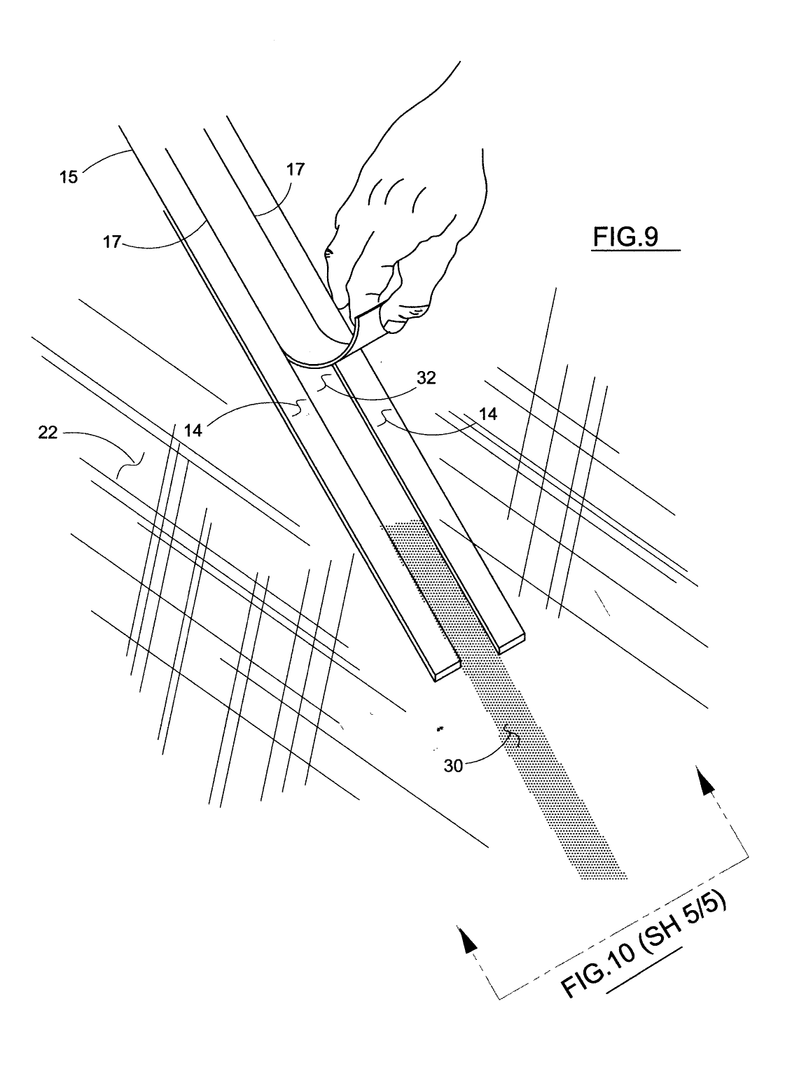

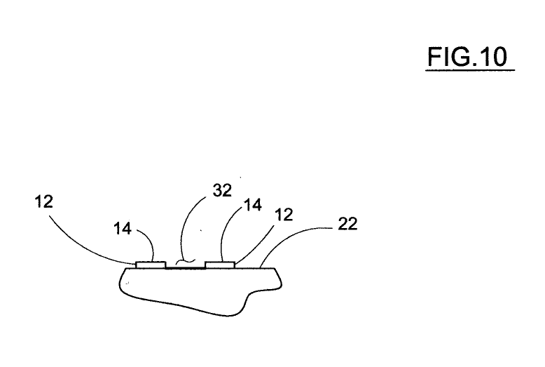

In one embodiment, as demonstrated in FIGS. 3 and 4, a pair of borders 36 is formed by base tape wire 12 whereby paint 30 is applied there between. When removing each border 36 a pair of parallel edges 34 defines painted area 30.

In another embodiment, as demonstrated in FIGS. 5 and 6, system 10 includes three parallel base tape liner 12 that impart two substantially parallel paint areas 30. In one embodiment, each paint area 30 has the same width. In another embodiment, each paint area 30 has a different width. The impetus of this embodiment of system 10 being to create two or more painted areas 30 having substantially parallel borders 34.

In another embodiment of the present invention, base tape liner 12 has formed therein a plurality of stenciled cut outs or patterns 40 whereby a user paints the interior portion of stencil 40 and upon removal of base tape 12 painted area 30 imparts a shape congruous to stencil pattern 40.

The user will unroll system 10 and affix surface 26 to a desired mounting surface 22. A desired length of unrolled system tape is cut and a user will press downward on to system 22 in order to make sure the system is firmly affixed into position. A user will grasp surface 20 and extended outward from surface 22 and expose paint cavity 32. A user will then paint utilizing paint 30 within paint cavity 32. Once painting is complete, depending on the paint used, a user will either wait for paint 32 dry, or alternatively without significant waiting remove all undesired based tape liner 12 portions from surface 22. The resultant paint deposited within paint cavity 32 will remain on surface 22.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A paint tape system comprising:
a base tape having a planer upper surface and planer lower surface having releasable adhesive disposed thereon; and
a releasable portion releasable from said base tape whereby removing said reliable portion imparts a paint channel.

2. The system of claim 1 including two base tape liners substantially parallel one to another.

3. The system of claim including three base tape liners substantially parallel to each other.

4. The system of claim 1 whereby said base tape liner includes a plurality of cut out stencil shapes incorporated thereon.

5. The system of claim 1 further including a second layer being a base tape liner having a planer upper surface and planer lower surface having releasable adhesive disposed thereon, said base tape liner, when mounted on a surface imparting at least paint receiving cavity constructed and arranged for applying paint therein.

6. A method of applying paint using a paint tape system, said method comprising the steps of:
providing a paint tape system of claim 1;
unrolling a desired length of tape from said system;
cutting said desired length;
affixing said base tape lined on a surface to be painted;
removing said base tape;
exposing said paint receiving cavity by said removing of said base tape liner;
applying paint to said paint receiving cavity;
optionally, waiting for said paint to dry; and
removing said base tape liner.
